(19) United States
(12) Patent Application Publication
(10) Pub. No.: US 2005/0083883 A1
(43) Pub. Date: Apr. 21, 2005

(54) Mobile network agent

(76) Inventors: Jan-Ming Ho, Taipei (TW); Chun-Hsin Wu, Taipei (TW); Ann-Tzung Cheng, Taipei (TW); Chih-Chung Huang, Taipei (TW)

Correspondence Address: Pavel POGODIN, Esq., 617 North Delaware Street, San Mateo, CA, 94401, US

(21) Appl. No.: 10/690,440

(22) Filed: Oct. 20, 2003

(51) Int. Cl. H04Q 7/00; H04B 7/00; G06F 15/16

(52) U.S. Cl. 370/331; 370/310; 709/245

(57) ABSTRACT

A mobile network agent is installed in any network system. The mobile network agent automatically obtains the identification information of a mobile device that requests to establish connection with the network system and authenticate the identity of the mobile device. The authentication information is notified to the network system and the home network or the virtual private network (VPN) server of the mobile device. Communication packages coming from the home network or the VPN are received by the mobile network agent directly and are transmitted to the mobile device. On the other hand, communications packages coming from the mobile device are transmitted to the home network or the VPN via the mobile network agent, to be processed by the latter. Under the present invention, even if the mobile device or its home network is not installed with the mobile network agent, a mobile device is allowed to roam from network to network via a network system installed with the mobile network agent of this invention.

### FIELD OF THE INVENTION

The present invention relates to a mobile network agent, especially to a mobile network agent that allows a mobile device to roam among IP segments with good communications quality.

### BACKGROUND OF THE INVENTION

Due to the highly development of the internet technology and the mobile communications technology, using a mobile device that is provided with mobile operation capability to connect with a wireless network system in order to access to desired information in the internet, has become a popular application. Roaming technologies have been developed to allow all kinds of mobile device, such as notebook computer, personal digital assistant etc., to roam among network systems or IP segments. International standards such as IEEE 802.1x were thus announced to meet the urgent need of such roaming applications.

The conventional roaming technology for mobile devices is established on the so-called AAA (authentication, authorization and accounting) infrastructure. Exchange of information between system operators that a mobile device is connected is conducted under information exchange protocols under the AAA infrastructure. Under such a structure, when a mobile device logs in a network system, an authentication process is required. The procedure includes authentication and authorization. After the procedure is complete, an account is given to the mobile device. Then, when the mobile device enters into the area covered by another network system, it has to log off the first network system and log in the second. The same authentication procedure shall be repeated, such that the mobile device is allowed to access to desired information via the second network system. Such log in and log off procedures are time-consuming and, nevertheless, would interrupt the information access operation of the mobile device. In some cases, the information access operation of the mobile device before the log off can not be retrieved or resumed.

In addition, in the conventional art, roaming of a mobile device to foreign networks is not allowed before it has authenticated and authorized by its home network. If the mobile device is not given an IP address by its home network, it will not be allowed to access information through network systems that provide the roaming service.

Firewalls are installed in many network systems. Firewalls will block the access of information from mobile devices or any computer equipment with which collision of IP address is found. When a mobile device is roaming among network systems, collision of IP address, such when two or more mobile devices using the same IP address given by different home networks request to connect to one network within a time period, is easy to take place. Results of such collision include: a warning signal being generated, errors in access of information, or access of information being prohibited.

Although the conventional art provided a variety ways for a mobile device to conduct roaming among networks, the mobile shall be installed with an authentication device or software before it can request the authentication and authorization procedure. Such requirement naturally cause inconvenience to users of mobile device.

It is thus necessary to provide a novel mobile network agent that may be installed at the network system, such that authentication of mobile devices may be conducted automatically.

It is also necessary to provide a mobile network agent that is able to authenticate mobile devices which is not installed with authentication tool, so to facilitate roaming services to ordinary mobile devices.

It is also necessary to provide a mobile network agent to eliminate the necessity of repeated authentication and authorization procedures while a mobile device is roaming among the networks.

It is also necessary to provide a mobile network agent to avoid interruption of information access during swift of network system to be connected by a mobile device.

### OBJECTIVES OF THE INVENTION

The objective of this invention is to provide a novel mobile network agent that may be installed at the network system, such that authentication of mobile devices may be conducted automatically.

Another objective of this invention is to provide a mobile network agent that is able to authenticate mobile devices which is not installed with authentication tool, so to facilitate roaming services to ordinary mobile devices.

Another objective of this invention is to provide a mobile network agent to eliminate the necessity of repeated authentication and authorization procedures while a mobile device is roaming among the networks.

Another objective of this invention is to provide a mobile network agent to avoid interruption of information access during swift of network system to be connected by a mobile device.

### SUMMARY OF THE INVENTION

According to this invention, a novel mobile network agent is provided. The mobile network agent of this invention may be installed in any network system. The mobile network agent automatically obtains the identification information of a mobile device that requests to establish connection with the network system and authenticate the identity of the mobile device. The authentication information is notified to the network system and the home network or the virtual private network (VPN) server of the mobile device. Communication packages coming from the home network or the VPN are received by the mobile network agent directly and is transmitted to the mobile device. On the other hand, communications packages coming from the mobile device are transmitted to the home network or the VPN via the mobile network agent, to be processed by the latter. Under the present invention, even if the mobile device or its home network is not installed with the mobile network agent, a mobile device is allowed to roam from network to network via a network system installed with the mobile network agent of this invention.

The above and other objectives and advantages may be clearly understood from the detailed description by referring to the following drawings.

### BRIEF DESCRIPTION OF THE DRAWINGS

FIG. 1 illustrates the systematic diagram of a network system.

FIG. 2 illustrates the systematic diagram of the mobile network agent of this invention.

FIG. 3 illustrates the communication model of the mobile network agent of this invention.

FIG. 4 illustrates the flowchart of IP collision resolution of the IP collision resolution module of this invention.

### DETAILED DESCRIPTION OF THE INVENTION

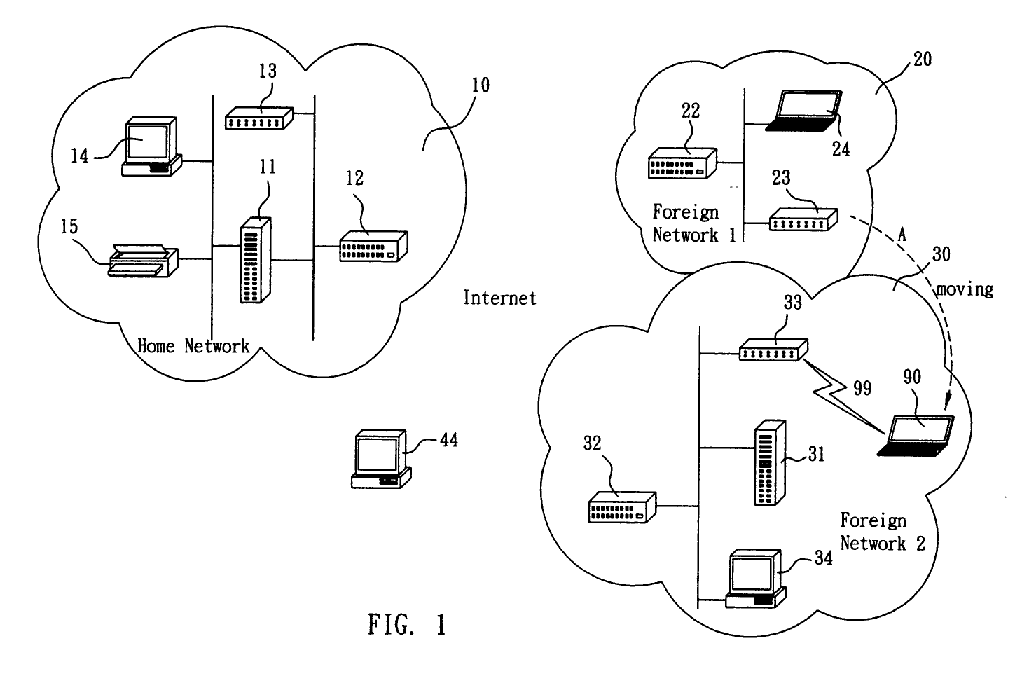

The embodiments of the mobile network agent of the invention will be illustrated in the followings by referring to the drawings. FIG. 1 illustrates the systematic diagram of a network system.

In FIG. 1, 10 pertains to the home network of the mobile device 90. The home network 10 includes a virtual private network (VPN) server 11, a gateway 12, a mobile network agent 13 a plurality of correspondence nodes (CN's) 14, a printer 15 and other equipments such as personal computers and communications equipments. The mobile device 90 has an IP address (account identity) given by the home network and a user ID given by the VPN server 11. The gateway 12 and the BPN server 11 respectively have their IP addresses to identify themselves in the internet.

In FIG. 1, the mobile device 90 is connected with the first foreign network system 20, while it is shifting from the first foreign network 20 to the second foreign network 30. The foreign networks 20 and 30 respectively have their own server 31, gateway or router 22, 32, mobile network agent 23, 33 and correspondence node 24, 34 etc. In addition, there are numerous correspondence nodes 44 existing in the whole network system. Number 99 indicates connection and arrow A represents shifting of connection.

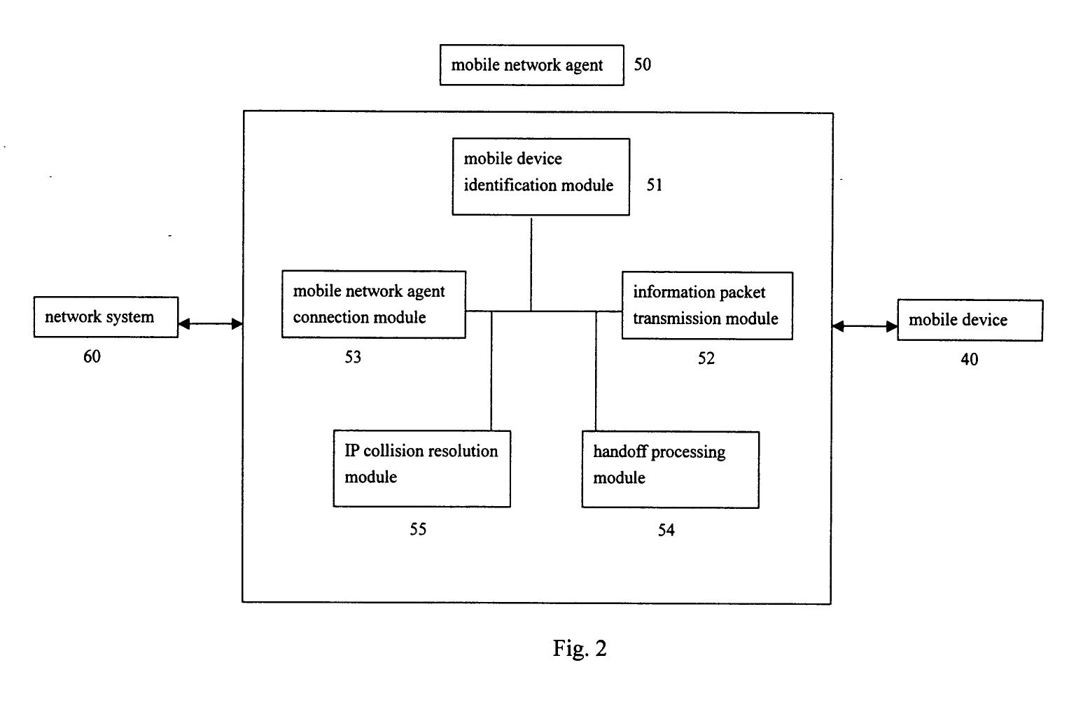

One major purpose of the mobile network agents 13, 23, 33 of this invention is to provide roaming services to the mobile device 90. FIG. 2 illustrates the systematic diagram of the mobile network agent of this invention.

As shown in this figure, the mobile network agent 50 of this invention connects the mobile device 40 and the network system 60 and comprises: a mobile device identification module 51 to grasp authentication information transmitted between the mobile device 40 and the VPN server of its home network system 10 to obtain the identification information of the mobile device 40, when the mobile device requests to log in; an information packet transmission module 52 to receive and to transmit information that said mobile device receives and transmits, respectively, through said network system 60; a mobile network agent connection module 53 to establish a communications channel between the mobile network agent 50 and the mobile network agent 13 of the home network system 10, if the home network system 10 is installed with such a mobile network agent; a handoff processing module 54 to obtain address information of the mobile device 40 as registered with a previously connected foreign network system relative to the mobile device 40 and to send a renew information to the previously connected foreign network system, when the mobile device requests to log in; and an IP collision resolution module 55 to identify and separately deliver the packets to and from mobile devices that have identical IP address or account identity or with other mobile device or computer equipment or system and that is in connection with the mobile network agent.

The mobile network agent of this invention is provided with a mobile device identification module 51 to automatically obtain the identification information of the mobile device 90. In the embodiments of this invention, the mobile device identification module 51 of the mobile network agent 50 obtains the authentication information of the mobile device 90, when it is establishing connection with the VPN server 11 of its home network system 10. In practice, the mobile device identification module 51 monitors the information packets from and to the mobile device 90 to grasp the identity information of the mobile device 90. The monitoring function of the mobile device identification module 51 is actuated when the mobile device 90 generates a request to the VPN server 11 of its home network system 10 to authenticate its identity. When the VPN server 11 responds and sends to the mobile device 90 an authentication packet, the authentication information contained in the authentication packet may be obtained. For example, if the VPN server is a PPTP (point-to-point tunneling protocol) server, the VPN server uses the PPP (point-to-point protocol) to transmit the authentication information and results of such authentication. Such an information packet is not encapsulated so that its content may be obtained and recorded by the mobile device identification module 51. Such authentication information is useful in the following process.

In some embodiments of this invention, the mobile device identification module 51 uses SNMP (Simple Network Management Protocol) to check the authentication of the mobile device. In that case, the mobile device identification module 51 may use “polling” or “trap” function to request the VPN server 11 to provide desired information. In addition, it is also possible to provide an interface at the VPN server 11 to allow the mobile device identification module 51 to check the authentication of the mobile device 90. Alternatively, a VPN server may be installed inside the mobile network agent to provide similar functions.

In practice, the request of the mobile device 90 is made to the first foreign network 20, not to the home network 10. Data transmission between the mobile device 90 and the first foreign network 20 is conducted under the communication protocol as used in ordinary network systems.

As shown in this figure, a mobile network agent 23 is installed in the first foreign network system 20. The mobile device identification module 51 of the mobile network agent 23 grasps the information packet transmitted between the mobile device 90 and the VPN server 11 of its home network system 10 to identify its identity. Communication packets to and from the mobile device 90 is guided by the mobile network agent 23 under the proxy address resolution protocol (ARP).

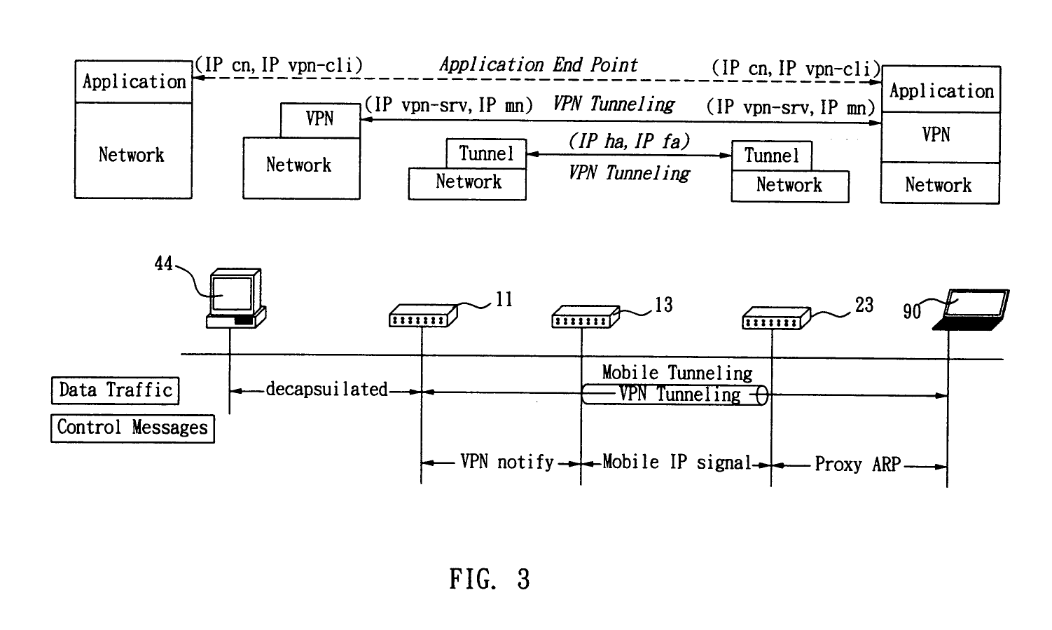

The function of the information packet transmission module 52 is to transmit and to receive information packet in replacement of the mobile device 90. FIG. 3 illustrates the communication model of the mobile network agent of this invention.

As shown in this figure, mobile network agents 13 and 23 are installed in the home network 10 and the first foreign network 20, respectively. The communication between the mobile device 90 and the correspondence nodes 44 is made via the VPN server 11 of the home network 10. Information as transmitted or received is decapsulated information.

Here, the correspondence nodes 44 may be a web server, an FTP server etc. Information packets received by the mobile device 90 contain IP address designated by the VPN server 13 to the mobile device 90 as a VPN client. The IP address is given to the mobile device 90 by the VPN server 13 after its connection with the home network 10 is completed. Such information may be used by the mobile device identification module 51 to identify the identity of the mobile device 90, although in some cases the IP address is converted to another IP address through the network address translation.

Information packets transmitted from the correspondence nodes 44 to the mobile device 90 are delivered to the mobile network agent 13 of the home network 10 based on ordinary IP routing rules in the first place and then to the first foreign network 20 from the home network 10, so that the information packet transmission module 52 of the mobile network agent 23 of the first foreign network 20 delivers them to the mobile device 90.

In the embodiment shown in FIG. 3, communication between the mobile device 90 and the VPN server 11 is made through the foreign mobile network agent 23 and the mobile network agent 13 of the home network 10. As a result, information packets are transmitted through the VPN tunneling between the mobile device 90 and the mobile network agent 13 of the home network 10. Applicable tunneling includes PPTP tunneling. In this tunneling, encapsulation and decapsulation of information packets are conducted by the mobile device 90 and the mobile network agents 13, 23.

Since communications between the mobile device 90 and the VPN server 11 of the home network system 10 are made through the mobile network agent 23 of the foreign network and the mobile network agent 13 of the home network 10, they can thus be realized by the mobile IP tunneling technology. Applicable approaches include IP-in-IP tunneling, GRE (generic routing encapsulation) tunneling etc. Encapsulation of information packets is conducted by the mobile network agents 13 and 23.

With the design as described above, when the mobile device 90 requests to connect with the VPN server 11 of its home network 10 through the first foreign network 20, such a request is sensed by both mobile network agents 13 and 23. As a result, communications between the mobile device 90 and the home network 10 are conducted under the control of both mobile network agents 13 and 23. In other words, both mobile agents 13 and 23 monitor the authentication information of the mobile device 90, obtain the identification information and establish their connection with the mobile device 90. Thereafter, all communications between the mobile device 90 and the VPN server 11 of its home network 10, and with the correspondence nodes 44, are conducted by the information packet transmission module 52 of the mobile network agents 13 and 23.

The mobile network agent of this invention provides a mobile network agent connection module 53 to establish direct communication channel with the mobile network agent 13 of the home network 10.

To establish the direct communication channel between two mobile network agents, a suited way may include: The foreign mobile network agent 23 generates a location update message to the IP address of the mobile device 90 at home network 10. According to the IP routing rules, the message is delivered to the home network 10. While the mobile network agent 13 of the home network 10 monitors such communications with, e.g., proxy ARP, the message is intercepted by the mobile network agent 13. Communication channel between both agents 13 and 23 is thus established. In this process, the mobile device 90 needs not to provide any additional information to the foreign mobile network agent 23.

The major function of the handoff processing module 54 is to control the shifting of connection with the mobile device 90 from one network segment to another. In the embodiment shown in FIG. 1, the mobile device 90 terminates its connection with the first foreign network system 20 and starts its connection with the second foreign network 30.

If the mobile device 90 uses the DHCP (dynamic host configuration protocol) to obtain its IP address from its home network 10, whenever a handoff takes place, the mobile device 90 will generate a DHCP request or a DHCP discover to obtain a new dynamic IP designation. In the embodiment of the present invention, the mobile network agent 33 of the second foreign network 30 uses the DHCP server (not shown) provided in the second foreign network 30 or a built-in DHCP server to conduct the handoff processing, such that the mobile device 90 may continue to use the old dynamic IP address. Of course it is possible to use other approaches to allow the mobile device 90 to continue using the original IP address and to maintain the connection.

If the second foreign network 30 is able to obtain the DHCP IP address of the first foreign network 20 from the DHCP request of the mobile device, the DHCP request or DHCP discover will be sent to the first foreign network 20, which was connected by the mobile device at a previous time point. If the information of the previously connected DHCP server already exists at the mobile network agent 33 of the second foreign network 30, such as in case where the mobile device has been connected with the second foreign network 30 and later shifted to another foreign network, the mobile network agent 33 of the second network 30 may also obtain the identification information of the mobile device through the mobile network agents of other foreign networks. The DHCP request or DHCP discover may thus be transmitted to the DHCP server that was in connection with the mobile device at a previous time point. Of course, it is possible for the mobile agent 33 to omit the step of relaying the DHCP request and the DHCP discover to the first foreign network 20.

On the other hand, if the second foreign network 30 is not able to obtain the information of the DHCP server previously in connection, but is able to obtain the dynamic IP address given to the mobile device at a previous time point, such as in the case where the DHCP request generated by the mobile device 90 contains the options of the requested IP, the mobile network agent 33 will assign the requested IP address to the mobile device, in replacement of the previous DHCP server. Otherwise, the DHCP server will assign to the mobile device 90 a new IP address. In this case, the VPN connection and authorization of the mobile device is terminated and the mobile device needs to obtain authentication and authorization again.

When the DHCP server of the first foreign network 20 receives the DHCP request or DHCP discover from the DHCP server of the second foreign network, it will renew the authorization given to the mobile device 90 to use the original IP address, following the rules as used in such a network system.

In another embodiment of this invention, the home network 10 of the mobile device 90 is not installed with the mobile network agent 13. In this case, when the mobile device connects the first foreign network 20 for the first time, the mobile device identification module 51 of the mobile network agent 23 of the first foreign network 20 automatically enquires the home network 20 of the mobile device 90 to provide the authentication information of the mobile device 90. The mobile network agent 23 utilizes the authentication information of the mobile device 90 to provide roaming services to the mobile device 90. Under such a structure, the mobile device 90 needs not to register or provide any additional account with the first foreign network 20, but just uses the account identification given to it by its home network 10, for which authorization was given to it at the first foreign network 20, to utilize all the resources of the internet.

Because there is no mobile network agent provided in the home network 10 to handle the mobile IP tunneling, the mobile agent 23 of the first foreign network 20 needs to provide the functions that should be provided by the mobile network agent of the home network 10 temporarily, such that the connection of the mobile device 90 with the network system may be maintained even after the mobile device 90 is shifted to the area of the second foreign network 30. For that reason, all the communication packets to and from the mobile device 90 are transmitted through the mobile IP tunneling between the mobile agents 23 and 13.

If the mobile device 90 uses the IP address given to it by the home network 10, but not by the first foreign network 20, the mobile network agent 23 may use the NAT (network address transfer) protocol to maintain the normal connection between the mobile device 90 and the VPN server 11 of its home network 10.

It is also possible to allow the mobile device 90 to use an IP address given by the first foreign network 20, For example, an IP address may be given to the mobile device 90 by the DHCP server of the first foreign network 20 through the DHCP. In either case, the communication between the mobile device 90 and the VPN server 11 of the home network 10 is relayed by the mobile network agent 23.

In the mobile network agent of this invention, an IP collision resolution module 55 is provided to solve any collision between the IP address or other account identification of the mobile device and the IP address, account number, representative symbols or another computer equipment.

In this invention the mobile device 90 uses the IP address given to it by his home network system 10. As a result, when two different mobile devices connect with one foreign network, collision of IP address is very easy to happen. The mobile network agent of this invention uses the technology of traffic separation to divide the traffic of two different mobile devices, so to solve the problem of IP collision. Such a traffic separation technology may be any known method, such as the VLAN (virtual local area network) technology, e.g., IEEE802.1Q. Of course, other technologies that is able to separate information traffics to and from different mobile devices with identical IP or mobile device and other computer equipments with identical IP are applicable to this invention.

When transmitting information, the information packets sent by the mobile device 90, including the frames at layer 2, such as ARP (access resolution protocol) information, will be added a VLAN tag or other identification code automatically. The VLAN tag is attached with the information packet when it travels all the way through to the mobile network agent. The receiving mobile network agent may identify sender of the information packet according to the VLAN tag.

If any other mobile network device generates an ARP request, asking for the MAC (media address control) address of the IP address, the ARP request will not be sent to the two mobile devices directly but, instead, the mobile network agent will respond to the ARP requests.

On the other hand, when receiving information, since all outgoing information flow of the mobile device goes through the VPN connection, it will be easy for the mobile network agent to identify and distinguish two different mobile devices with the same IP address from the IP addresses of their IPN servers. This is because in most cases the two mobile devices won't belong to the same VPN server. It is thus preferable for the mobile network agent to identify a mobile device by “the IP address of the VPN server of its home network system” plus ‘the IP address of its home network system”, instead of just the IP address of the home network.

If there is a collision between the IP address of the home network of the mobile device and the DNS (domain name system) or gateway of other mobile device, such as in the case where the IP address of a mobile device is the IP address of the DNS of another mobile device, the information traffics belonging to the mobile devices may be separated with the VLAN technology to solve the collision.

In addition, if the IP address of the home network of the mobile device is identical to the IP address of the mobile network agent, the mobile network agent must use VLAN to separate the information flow of the mobile device. When the mobile device generates an ARP request to see if the IP has been occupied by another, the mobile network agent shall not respond to that request. At this time, the mobile network agent shall masquerade itself and use another IP address that is not in collision.

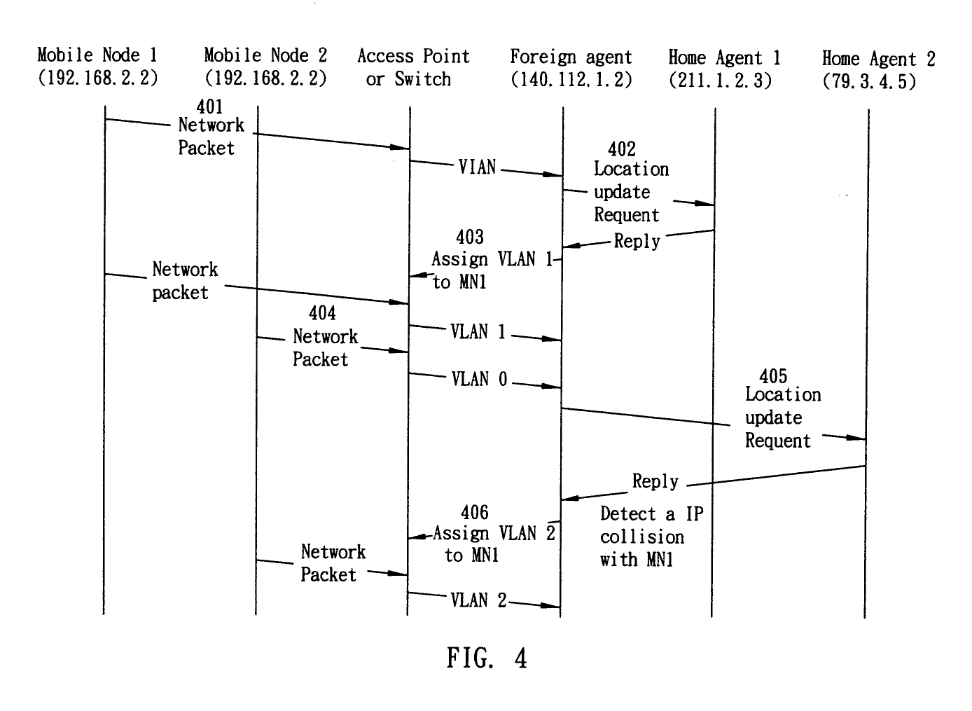

FIG. 4 illustrates the flowchart of IP collision resolution of the 11′ collision resolution module of this invention.

As shown in this figure, at 401 the first mobile device enters into the area covered by the foreign network system. Before the authentication of the first mobile device is completed, the wireless network access point or the network switch of the foreign network uses the default VLAN 0 IP to transmit information packets of the first mobile device. When, at 402, the IP renew and network authentication of the mobile network agent of the foreign network and the home network is completed, the foreign network will assign to the first mobile device a VLAN ID at 403. As shown in this figure, the access point or the switch use VLAN 1 to transmit information packets to and from the first mobile device.

At 404 a second mobile device enters into the area covered by the foreign network. The second mobile device has the identical IP address of the first mobile device. Similarly, before authentication to the second mobile device is completed, transmission of information packets to and from the second mobile device uses a default VLAN ID. At this time, although the first and the second mobile devices use the same IP address, communications with them do not interfere with each other, since they are at different VLANs.

At 405 the IP renew of and the network authentication of the second mobile device is completed. The foreign network assigns a VLAN ID, which has no collision with the IP of the first mobile device, to the second mobile device. As shown in this figure, bearing in mind that the first mobile device is dispatched to VLAN 1, the foreign network dispatch the second mobile device to VLAN 2.

The VLAN structure of IEEE 802.1Q provides the possibility of dividing a physical area network into a plurality of virtual networks. Although two mobile devices connect to the same physical network, the information traffic to and from the respective mobile devices can be separated and delivered to different area networks. Interference of information flow can thus be avoided. According to IEEE 802.1 Q, the maximum amount of VLAN may be 4096. For a mobile network agent, it is possible to allow 4096 mobile devices which use the same IP address to connect to it.

### EFFECTS OF THE INVENTION

The mobile network agent of this invention allows a mobile device to use the IP address given to it by its home network to access information, no matter which network (subnet) it is connecting. The mobile device is allowed to roam among different foreign networks, while communications that are already established won't be interrupted. When the mobile device is roaming among foreign networks, no correspondent nodes that are communicating with the mobile device need not to identify the fact that the mobile device is no longer connected with the home network. When the connection of the mobile device is shifted to a new foreign network or subnet or IP segment, the original VPN connection needs not to be interrupted. Reconnection procedure is thus omitted.

Mobile devices to which the mobile network agent may be used may be an ordinary mobile device platform, as long as it can support the relative IP network protocol and VPN protocol. It is thus not necessary to upgrade the software system of the mobile device or to install a special system to support particular communication protocol, in order to utilize the mobile network agent of this invention. Taking personal computer or notebook computer for example, any such machine with Microsoft Windows, UNIX-like OS, MAC OS may use the invented mobile network agent. Taking PDA for example, a machine with PALM OS, Microsoft WinCE or Linux can use the invented mobile network agent. Any handset with the capability of IP network access and VPN connection can use the invented mobile network agent.

The mobile network agent of this invention automatically identifies the identity of the mobile device. Except during the procedure of the VPN connection, the mobile device needs not to proceed any authentication procedure or to provide any additional identification information. Information sent to and from the mobile device may be encapsulated. After the VPN connection between the mobile device and its home network is completed, the identification of the mobile device may be easily recognized by the mobile network agent, so to provide roaming service to the mobile device.

As the present invention has been shown and described with reference to preferred embodiments thereof, those skilled in the art will recognize that the above and other changes may be made therein without departing form the spirit and scope of the invention.

1. A mobile network agent to allow a mobile device to connect with home network of said mobile device through a foreign network, wherein said home network and said forging network are connectable to each other, comprising:
a mobile device identification module to grasp authentication information transmitted between said mobile device and said home network system to obtain identification information of said mobile device;
an information packet transmission module to receive and to transmit information packets that said mobile device receives and transmits, respectively, through said foreign network;
a mobile network agent connection module to establish a communication channel between said mobile network agent and another mobile network agent;
a handoff processing module to obtain address information of the mobile device as registered with a foreign network previously connected with said mobile device and to send a renew information to said previously connected foreign network, when said mobile device requests to log in; and
an IP collision resolution module to separate information packets to and from mobile devices that are connected to said mobile network agent and have identical IP address or account identity or information flow to and from a mobile device that is connected to said mobile network agent and has an IP address or account identity identical with that of another mobile device or computer equipment.

2. The mobile network agent according to claim 1 wherein said mobile device identification module is actuated when said mobile device requests to connect with said mobile network agent.

3. The mobile network agent according to claim 1 wherein said mobile device identification module identifies identification of said mobile device when said mobile device establishes connection with the VPN server of said home network.

4. The mobile network agent according to claim 1 wherein said mobile device identification module obtain identification information of said mobile device by requesting said identification information to home network of said mobile device.

5. The mobile network agent according to claim 1 wherein said information packets are transmitted between said mobile network agent and another mobile network agent provided in said home network.

6. The mobile network agent according to claim 5 wherein information packets transmitted between said mobile network agent and said other mobile network agent through a mobile IP tunnel.

7. The mobile network agent according to claim 1 wherein said handoff processing module is actuated by the DHCP request or DHCP discover signal of said mobile device.

8. The mobile network agent according to claim 7 wherein said handoff processing module transmits said DHCP request or DHCP discover signal to a network system that is in connection with said mobile device to renew IP authorization given to said mobile device by said network system.

9. The mobile network agent according to claim 1 wherein said IP collision resolution module generates different identification codes and attaches said codes to to and from different mobile devices with identical IP or mobile device and other computer equipments with identical IP to separate information flaws.

10. The mobile network agent according to claim 9 wherein said identification code is a VLAN (virtual local area network) tag.

11. The mobile network agent according to claim 9 wherein said identification code is added to information packets generated by said mobile device.

12. The mobile network agent according to claim 1 wherein said identification code is added to information packets designated to said mobile device.
